(19) United States
(12) Patent Application Publication
(10) Pub. No.: US 2024/0002759 A1
(43) Pub. Date: Jan. 4, 2024

(54) LOW CARBOHYDRATE BEER AND METHODS OF MAKING

(71) Applicant: Anheuser-Busch, LLC, St. Louis, MO (US)

(72) Inventors: Rachel HOOPER, St. Louis, MO (US); John CORRY, St. Louis, MO (US)

(21) Appl. No.: 18/038,173

(22) PCT Filed: Dec. 3, 2021
(86) PCT No.: PCT/US2021/072732

§ 371 Date: May 22, 2023

Related U.S. Application Data
(60) Provisional application No. 63/225,173, filed on Jul. 23, 2021.
(60) Provisional application No. 63/120,958, filed on Dec. 3, 2020.

(51) Int. Cl. C12C 12/02; C12H 1/07; C12C 11/11; C12C 5/02; B01D 61/02

(52) U.S. Cl. CPC C12C 12/02; C12H 1/063; B01D 2311/06; C12C 5/02; B01D 61/026; C12C 11/11

(57) ABSTRACT

Provided herein are methods of making a beer beverage, wherein a fermented malt beverage is filtered using one or more filtration stages. In various embodiments, beer beverages that are produced using the methods provided herein may have an increased real degree of fermentation (RDF) and/or may have a reduced carbohydrate content. In particularly preferred embodiments, beer beverages produced using the methods provided herein have a carbohydrate content of less than 0.5 grams per 12 fluid ounces.

### CROSS REFERENCE TO RELATED APPLICATIONS

This application claims priority to U.S. Provisional Application No. 63/120,958, filed on Dec. 3, 2020, and to U.S. Provisional Application No. 63/225,173, filed on Jul. 23, 2021, each of which is incorporated herein by reference in its entirety.

### FIELD

The present disclosure relates to methods of making beer, for example beer having reduced (i.e., low or no) carbohydrate content. The present disclosure is also directed to beer beverages prepared using the methods provided herein.

### BACKGROUND

There is an increasing desire for beer beverages that are free of gluten, have relatively low calories, and that have low or no carbohydrate content. Beer beverages having less than 0.5 grams of carbohydrates per serving, which may be marketed as “zero carb” beverages in the United States, are particularly desirable.

Previous attempts to prepare beer beverages have suffered from a number of drawbacks. For example, there are a number of very low carbohydrate beers (or beer-like beverages) that have little or no alcohol content. Traditional beers, in contrast, typically have an alcohol content of from about 2% to about 8% alcohol by volume (ABV). Other attempts to prepare very low carbohydrate beers have resulted in beverages having undesirable aromas or flavors dissimilar from that of traditional beer.

There is therefore a need in the industry for methods of making beer beverages having a reduced carbohydrate content, an alcohol content similar to that of traditional light beers, and a taste profile similar to that of conventional light beers.

### SUMMARY

Provided herein is a method of making a beer beverage, wherein a fermented malt beverage is filtered using one or more filtration stages as described herein.

For example, in one aspect, provided herein is a method of producing a beer beverage having a reduced carbohydrate content, the method comprising (a) providing a fermented malt beverage; (b) subjecting the fermented malt beverage to a reverse osmosis stage, thereby producing a reverse osmosis permeate; and (c) combining the reverse osmosis permeate with hops or an extract thereof; thereby producing a beer beverage having a carbohydrate content of less than 0.5 grams per 12 fluid ounces (or equivalently, per 355 mL serving).

In another aspect, provided herein is a method of producing a beer beverage having a reduced carbohydrate content, the method comprising (a) providing a fermented malt beverage; (b) subjecting the fermented malt beverage to a reverse osmosis stage, thereby producing a reverse osmosis permeate; and (c) combining the reverse osmosis permeate with hops or an extract thereof; thereby producing a beer beverage having a carbohydrate content of less than 0.5 grams per 12 fluid ounces (or equivalently, per 355 mL serving).

In another aspect, provided herein is a method of producing a beer beverage having an increased real degree of fermentation (RDF), the method comprising: (a) providing a fermented malt beverage; (b) subjecting the fermented malt beverage to a reverse osmosis stage, thereby producing a reverse osmosis permeate; and (c) combining the reverse osmosis permeate with hops or an extract thereof; thereby producing a beer beverage having an RDF of at least about 94.

In another aspect, provided herein is a method of producing a beer beverage having an increased real degree of fermentation (RDF), the method comprising (a) providing a fermented malt beverage; (b) subjecting the fermented malt beverage to a reverse osmosis stage, thereby producing a reverse osmosis permeate; and (c) combining the reverse osmosis permeate with hops or an extract thereof; thereby producing a beer beverage having an RDF of at least about 94.

For example, in preferred embodiments, the fermented malt fermented malt beverage is prepared via fermentation of an aqueous malt mixture, wherein the aqueous malt mixture comprises, consists essentially of, or consists of barley malt, yeast, water, and optionally rice. In particularly preferred embodiments, the fermented malt beverage does not comprise hops.

In another aspect, provided herein is a beer beverage having a reduced carbohydrate content. In preferred embodiments, the beer beverage may have a carbohydrate content of less than about 2.5 grams, less than about 2 grams, less than about 1.5 grams, less than about 1 gram, or less than about 0.5 grams per serving (e.g., per 12 fluid ounce serving, or equivalently, per 355 mL serving)). In particularly preferred embodiments, the beer beverage is a “zero carb” beer comprising a carbohydrate content of less than 0.5 grams of carbohydrates per 12 fluid ounce serving (or equivalently, per 355 mL serving).

In another aspect, provided herein is a beer beverage having an increased real degree of fermentation. In preferred embodiments, the beer beverage has a real degree of fermentation of at least about 94, at least about 94.5, at least about 95, at least about 95.5, at least about 96, at least about 96.5, at least about 97, at least about 97.5, at least about 98, at least about 98.5, at least about 99, or at least about 99.5.

These and other aspects of the present disclosure are described in further detail below.

### DESCRIPTION OF THE DRAWINGS

For a better understanding of certain exemplary embodiments of the present disclosure, reference may be made to the accompanying drawings in which:

FIG. 1 depicts an exemplary embodiment wherein a fermented malt beverage is subjected to a reverse osmosis filtration stage.

FIG. 2 depicts an exemplary embodiment wherein the reverse osmosis stage comprises a plurality of reverse osmosis units.

### DETAILED DESCRIPTION

Provided herein are methods of making a beer beverage, wherein a fermented malt beverage is filtered using reverse osmosis. Beer beverages that are produced using the methods provided herein may, for example, have an increased real degree of fermentation (RDF) and/or a reduced carbohydrate content. In some embodiments, the methods provided herein enable the production of low carbohydrate—or even, in some embodiments, zero carbohydrate—beer beverages without significantly reducing the alcohol content of the beverage. Advantageously, beer beverages produced using the methods provided herein may also exhibit a pleasant taste and mouthfeel similar to that of traditional, high-carbohydrate beers.

Reduced Carbohydrate Content

As used herein, a “reduced carbohydrate content” means that the beer beverage contains a reduced content of carbohydrates as compared to the fermented malt beverage from which it was derived (i.e., prior to any reverse osmosis filtration stages as described herein).

For example, the methods described herein may produce a beer beverage wherein the carbohydrate content is reduced by at least about 10%, at least about 20%, at least about 30%, at least about 40%, at least about 50%, at least about 60%, at least about 70%, at least about 80%, or at least about 90% as compared to the fermented malt beverage prior to any filtration stages (for example, reverse osmosis filtration stages) as described herein.

For example, the beer beverage may comprise a carbohydrate content of less than about 2.5 grams, less than about 2 grams, less than about 1.5 grams, less than about 1 gram, or less than about 0.5 grams per serving (e.g., per 12 fluid ounce serving). In particularly preferred embodiments, the beer beverage comprises a carbohydrate content of less than 0.5 grams of carbohydrates per 12 fluid ounce serving. Equivalently, in particularly preferred embodiments, the beer beverage comprises a carbohydrate content of less than 0.5 grams of carbohydrates per 355 ml serving.

Real Degree of Fermentation

The methods provided herein may be utilized to produce beer beverages having a relatively high real degree of fermentation (RDF). In the context of a fermented beverage, the RDF reflects the degree to which carbohydrates present in the wort have been fermented into alcohol. The mouthfeel of a beverage is largely determined by its RDF; beverages having a higher RDF taste “lighter” or “drier,” while beverages having a lower RDF may have a “round” or even “syrupy” mouthfeel.

For example, the methods described herein may produce a beer beverage having an RDF of at least about 94, at least about 94.5, at least about 95, at least about 95.5, at least about 96, at least about 96.5, at least about 97, at least about 97.5, at least about 98, at least about 98.5, at least about 99, or at least about 99.5.

### Fermented Malt Beverage

The processes described herein comprise providing a fermented malt beverage. As used herein, the term “fermented malt beverage” refers to a carbonated, alcoholic beverage comprising fermented barley malt.

For example, the fermented malt beverage may be prepared via fermentation of an aqueous malt mixture, wherein the aqueous malt mixture comprises, consists essentially of, or consists of barley malt, yeast, and water. Optionally, the fermented malt beverage may comprise one or more conventional beer brewing adjuncts. Non-limiting examples of conventional beer brewing adjuncts include grains, such as rice, corn or wheat; and sugars, such as cane sugar and dextrose. As a non-limiting example, the aqueous malt mixture may comprise, consist essentially of, or consist of barley malt, yeast, rice, and water.

It is preferred that the aqueous malt mixture does not comprise hops. As discussed in further detail below, it has been observed that when the aqueous malt mixture comprises hops, the reverse osmosis filtration stage produces a low-carbohydrate beer having undesirable flavor components (e.g., flavors similar to cabbage). Accordingly, in preferred embodiments, the fermented malt beverage does not comprise hops (including “dry hops” added during or after the fermentation process).

Typically, the fermented malt beverage has an RDF of greater than about 80 but less than about 92. For example, the fermented malt beverage may have an RDF of at least about 81, at least about 82, at least about 83, at least about 84, at least about 85, at least about 85.5, at least about 86, or at least about 86.5. The fermented malt beverage typically has an RDF of at most about 92, at most about 91, at most about 90, at most about 89, at most about 88, or at most about 87. As a non-limiting example, the fermented malt beverage may have an RDF of from about 84 to about 88.

The fermented malt beverage typically has an alcohol content of at least about 2%, at least about 3%, at least about 4%, at least about 5%, at least about 6%, at least about 7%, or at least about 8% alcohol by volume (ABV). Typically, the fermented malt beverage has an alcohol content of less than about 15%, less than about 14%, less than about 13%, less than about 12%, less than about 11%, or less than about 10% ABV. For example, the fermented malt beverage may have an alcohol content of from about 9% to about 12%, or from about 10% to about 11% ABV. In other embodiments, the fermented malt beverage may have an alcohol content of from about 2% to about 8%, or from about 2% to about 6% ABV.

The fermented malt beverage typically comprises a carbohydrate content of at least about 1 gram, at least about 1.5 grams, at least about 2 grams, at least about 2.5 grams, at least about 3 grams, at least about 3.5 grams, at least about 4 grams, at least about 4.5 grams, or even at least about 5 grams per serving (e.g., per 12 fluid ounce serving, or equivalently, per 355 mL serving).

### Conventional Beer Filtration Stages

The processes described herein may optionally comprise one or more conventional beer filtration stages. The conventional beer filtration stages may comprise, for example, filtering a beverage fraction comprising, consisting essentially of, or consisting of the fermented malt beverage.

Filtration has been used since ancient times to remove suspended solids and sediment from beer and related products. In modern practice, conventional filtration is commonly used to remove yeast and/or reduce the turbidity of beer and malt beverages. As used herein, the term “conventional filtration” refers to the use of sieves or other filtration media having a pore size of at least about 0.1 micron, typically ranging up to about 10 microns or greater. Filtration media suitable for conventional filtration of beer and fermented malt beverages are widely available and familiar to those skilled in the art.

Conventional filtration techniques do not significantly change the RDF of beer or fermented malt beverages. Likewise, conventional filtration techniques do not significantly change the carbohydrate content of beer or fermented malt beverages.

In embodiments where the process comprises passing the fermented malt beverage through one or more conventional filtration stages, the fermented malt beverage typically has an RDF of greater than about 80 but less than about 92. For example, the fermented malt beverage typically has an RDF of at most about 92, at most about 91, at most about 90, at most about 89, at most about 88, or at most about 87 upon exiting the one or more conventional filtration stages.

In embodiments where the process comprises passing the fermented malt beverage through one or more conventional filtration stages, the fermented malt beverage typically has a carbohydrate content of at least about 0.5 grams, at least about 1 gram, at least about 1.5 grams, at least about 2 grams, at least about 2.5 grams, at least about 3 grams, at least about 3.5 grams, at least about 4 grams, at least about 4.5 grams, or even at least about 5 grams per serving (e.g., per 12 fluid ounce serving, or equivalently, per 355 mL serving) upon exiting the one or more conventional filtration stages.

### Reverse Osmosis

The processes described herein may comprise a reverse osmosis stage wherein a beverage fraction is passed through one or more reverse osmosis (RO) units to produce a reverse osmosis permeate and a reverse osmosis concentrate. For example, in some embodiments, the reverse osmosis stage comprises two or more reverse osmosis units.

In a reverse osmosis stage as described herein, the beverage fraction entering the reverse osmosis stage is forced through a partially permeable membrane. Typically, membranes used for reverse osmosis are either nonporous or have pores no greater than about 1-2 nanometers in size. Accordingly, in some embodiments, at least about 90% of monovalent ions and organic molecules having a molecular weight greater than about 50 daltons that enter the reverse osmosis stage are captured by the reverse osmosis concentrate (i.e., less than about 10% of such ions and molecules pass through to the reverse osmosis permeate).

The beverage fraction entering the reverse osmosis stage may comprise water, the fermented malt beverage, the permeate, concentrate, or retentate of any filtration or separation process, or any mixture or combination thereof. For example, the beverage fraction entering the reverse osmosis stage may comprise, consist essentially of, or consist of the fermented malt beverage.

The beverage fraction entering the reverse osmosis stage may optionally comprise one or more components that have been subjected to a conventional beer filtration stage as described above.

Without being bound to a particular theory, a reverse osmosis stage as described herein has been observed to promote the removal of unfermented carbohydrates from the beverage fraction entering the reverse osmosis stage. The reverse osmosis stage therefore produces a reverse osmosis permeate with a higher RDF than the beverage fraction entering the reverse osmosis stage. Likewise, the reverse osmosis stage produces a reverse osmosis permeate with a lower carbohydrate content than the beverage fraction entering the reverse osmosis stage

Surprisingly, it has been observed that the reverse osmosis stage is more efficient at increasing RDF, and removing carbohydrates, when the beverage fraction enters the one or more reverse osmosis units at a relatively high temperature. In preferred embodiments, the beverage fraction entering the reverse osmosis stage (and preferably, the stream entering each reverse osmosis unit) has a temperature of about 7° C. or greater. For example, the beverage fraction entering one or more reverse osmosis units may have a temperature of from about 1.5° C. to about 18° C., from about 1.5° C. to about 16° C., from about 4° C. to about 16° C., or from about 7° C. to about 13° C. For example, the beverage fraction entering one or more reverse osmosis units may have a temperature of at least about ° C., at least about 1° C., at least about 2° C., at least about 3° C., at least about 4° C., at least about 5° C., at least about 6° C., at least about 7° C., at least about 8° C., at least about 9° C., or at least about 10° C. Correspondingly, in preferred embodiments, the beverage fraction entering one or more reverse osmosis units (and preferably, the stream entering each reverse osmosis unit) has a temperature of at least about 30° F., at least about 35° F., at least about ° F., or at least about 45° F. As non-limiting examples, the beverage fraction entering one or more reverse osmosis units may have a temperature of from about 30° F. to about 65° F., from about 35° F. to about 60° F., from about 40° F. to about 60° F., or from about 45° F. to about 55° F. For example, the beverage fraction may enter each reverse osmosis unit at a temperature of at least about 35° F., at least about 40° F., at least about 45° F., or at least about ° F.

It has also been observed that the reverse osmosis stage increases RDF more effectively at higher operating pressures, particularly in excess of 6000 kPa. Accordingly, in preferred embodiments, the beverage fraction enters one or more reverse osmosis units (and more preferably, enters each reverse osmosis unit) at a pressure of at least about 6000 kPa. For example, the beverage fraction may enter one or more reverse osmosis units at a pressure of at least about 4750 kPa, at least about 5500 kPa, at least about 5750 kPa, or at least about 6000 kPa. It has been further observed that pressures above about 7000 kPa provide diminishing returns with respect to RDF removal, while increasing the risk of equipment failure. Accordingly, in preferred embodiments, the beverage fraction enters each reverse osmosis unit at pressure of from about 6000 kPa to about 7000 kPa. Correspondingly, the beverage fraction may enter each reverse osmosis unit at a pressure of at least about 900 psi. For example, the beverage fraction may enter each reverse osmosis unit at a pressure of at least about 700 psi, at least about 800 psi, at least about 850 psi, or at least about 900 psi. In preferred embodiments, the beverage fraction may enter each reverse osmosis unit at pressure of from about 900 psi to about 1000 psi.

Typically, the beverage fraction exits each reverse osmosis unit at a pressure of less than about 400 kPa, less than about 350 kPa, less than about 300 kPa, less than about 250 kPa, less than about 200 kPa, less than about 150 kPa, or less than about 100 kPa. For example, the beverage fraction may exit each reverse osmosis unit at a pressure of from about kPa to about 350 kPa, from about 25 kPa to about 275 kPa, from about 35 kPa to about 200 kPa, or from about 35 kPa to about 125 kPa. Correspondingly, the beverage fraction may exit each reverse osmosis unit at a pressure of less than about 50 psi, less than about 40 psi, less than about 30 psi, or less than about 20 psi. For example, the beverage fraction may exit each reverse osmosis unit at a pressure of from about 2 psi to about 50 psi, from about 4 psi to about 40 psi, from about 5 psi to about 30 psi, or from about 5 psi to about 20 psi.

The reverse osmosis stage acts to reduce the carbohydrate content of the beverage fraction that passes through it. The carbohydrate content of the reverse osmosis permeate may be reduced by at least about 10%, at least about 20%, at least about 30%, at least about 40%, at least about 50%, at least about 60%, at least about 70%, at least about 80%, or at least about 90% as compared to the beverage fraction entering the reverse osmosis stage. For example, the reverse osmosis permeate may comprise a carbohydrate content of less than about 2.5 grams, less than about 2 grams, less than about 1.5 grams, less than about 1 gram, or less than about 0.5 grams per serving (e.g., per 12 fluid ounce serving, or equivalently, per 355 mL serving). In particularly preferred embodiments, the beer beverage comprises a carbohydrate content of less than 0.5 grams of carbohydrates per 12 fluid ounce serving (or equivalently, per 355 mL serving).

In preferred embodiments, the reverse osmosis stage does not substantially reduce the alcohol content of the beverage fraction that passes through it. For example, the reverse osmosis permeate preferably retains at least about 50%, at least about 60%, at least about 70%, at least about 80%, at least about 90%, at least about 95%, at least about 98%, or at least about 99% of the alcohol content of the beverage fraction entering the reverse osmosis stage. For example, the alcohol content of the reverse osmosis permeate may be at least about 1%, at least about 1.5%, at least about 2%, at least about 2.5%, at least about 3%, at least about 4%, at least about 5%, at least about 6%, at least about 7%, or at least about 8% alcohol by volume (ABV). Typically, the alcohol content of the reverse osmosis permeate will less than about 15%, less than about 10%, less than about 8%, less than about 6%, less than about 5%, or less than about 4.5%. For example, the alcohol content of the reverse osmosis permeate may range from about 2% to about 10%, from about 2% to about 8%, from about 2% to about 6%, from about 2% to about 5%, from about 2% to about 4.5%, or from about 3% to about 5% alcohol by volume.

The reverse osmosis stage may comprise a single reverse osmosis unit or a plurality of reverse osmosis units. For example, the reverse osmosis stage may comprise at least two, at least three, at least four, or at least five reverse osmosis units. The plurality of reverse osmosis units may be arranged in series, in parallel, or a combination thereof. Typically, when multiple reverse osmosis units are used, the permeate from each unit will be captured and used as the feed to the following reverse osmosis unit (excepting the final unit, which produces the reverse osmosis permeate that exits the reverse osmosis stage).

The reverse osmosis concentrate may be discarded or stored for future use.

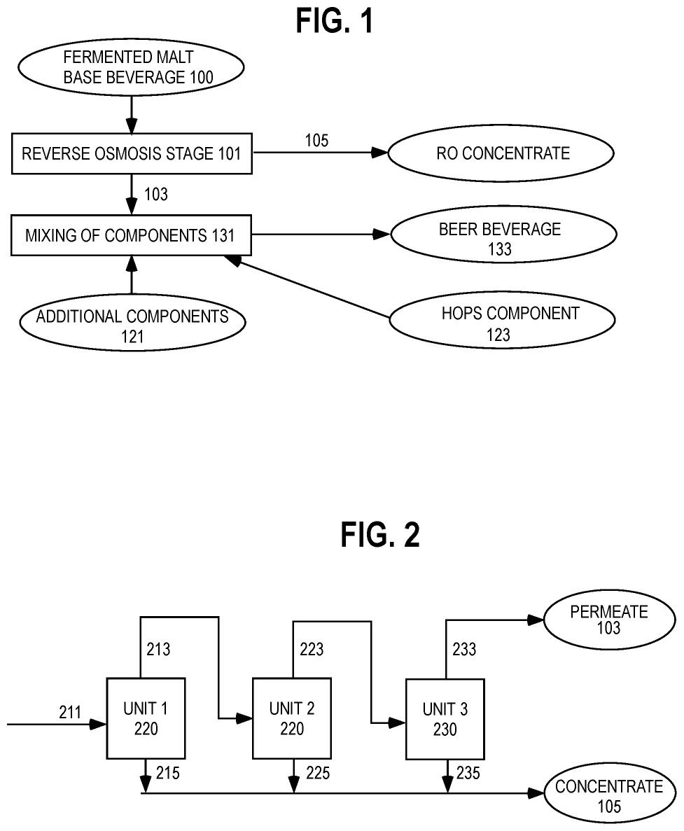

Referring now to the drawings and initially to FIG. 1, in an exemplary embodiment, a fermented malt beverage 100 is subjected to a reverse osmosis filtration stage 101, thereby producing a RO permeate 103 and a RO concentrate 105. In the exemplary embodiment shown in FIG. 1, the RO permeate 103 is then combined with one or more additional components 121 (which may comprise one or more natural and artificial flavoring agents, coloring agents, preservatives, stabilizers, or other ingredients as described in further detail below) and with a hop component 123, thereby producing a beer beverage 133.

FIG. 2 depicts an exemplary embodiment wherein the reverse osmosis stage 101 comprises a plurality of reverse osmosis units (identified with numerals 210, 220, and 230). In this example, the beverage fraction 211 entering the reverse osmosis stage is passed through a first reverse osmosis unit 210, producing a first permeate 213 and a first concentrate 215. The permeate 213 is then passed through a second reverse osmosis unit 220, thereby producing a second permeate 223 and a second concentrate 225. The permeate 223 is then passed through a third reverse osmosis unit 230, thereby producing a third permeate 233 and a third concentrate 235. In this example, permeate 233 exits the reverse osmosis stage as the RO permeate 103. The concentrate streams 215, 225, and 235 are combined and exit the reverse osmosis stage as the RO concentrate 105.

### Preparation of a Beverage

The processes described herein may further comprise a beverage preparation stage wherein the reverse osmosis permeate is combined with one or more additional components, thereby producing a beverage. When the beverage comprises a hops component, it may be referred to herein as a “beer beverage.” A beverage prepared without a hops component may be referred to herein as a “filtered malt beverage.”

For example, the beverage preparation stage may comprise combining the reverse osmosis permeate with one or more beverage fractions selected from the group consisting of the fermented malt beverage and water.

The beverage preparation stage may comprise combining the reverse osmosis permeate with one or more additional components. Non-limiting examples of additional components that may be added following the reverse osmosis stage include natural or artificial flavoring agents, coloring agents, preservatives, and stabilizers.

In a preferred embodiment, the beverage preparation stage comprises combining the reverse osmosis permeate with a hops component. The hops component comprises hops or an extract or essence thereof.

Without being bound to a particular theory, it has been observed that the reverse osmosis filtration stage will remove some, but not all, flavors provided by hops. When hops are added to the fermented malt beverage prior to the reverse osmosis stage, the resulting low-carbohydrate beer has been observed to have undesirable flavor components (e.g., flavors similar to cabbage). Accordingly, in preferred embodiments, the fermented malt beverage entering the reverse osmosis stage is free of hops (i.e., is free of hop plant material or a derivative thereof, such as hops extract or essence).

Advantageously, it has been discovered that hops, or an extract or essence thereof, can be incorporated into the beer beverage following the reverse osmosis stage, resulting in a pleasant taste and mouthfeel similar to that of traditional, high-carbohydrate beers. For example, in preferred embodiments, the reverse osmosis permeate is combined with a component comprising hops, or an essence or extract thereof.

### Beer Beverages

Beer beverages prepared using the methods provided herein are also within the scope of the present disclosure.

For example, provided herein is a beer beverage having a carbohydrate content of less than about 2.5 grams, less than about 2 grams, less than about 1.5 grams, less than about 1 gram, or less than about 0.5 grams per serving (e.g., per 12 fluid ounce serving). In particularly preferred embodiments, the beer beverage is a “zero carb” beer comprising a carbohydrate content of less than 0.5 grams of carbohydrates per 12 fluid ounce serving.

The beer beverage may have an RDF of at least about 94, at least about 94.5, at least about 95, at least about 95.5, at least about 96, at least about 96.5, at least about 97, at least about 97.5, at least about 98, at least about 98.5, at least about 99, or at least about 99.5.

The beer beverage may have an alcohol content of at least about 1%, at least about 1.5%, at least about 2%, at least about 2.5%, at least about 3%, at least about 4%, at least about 5%, at least about 6%, at least about 7%, or at least about 8% alcohol by volume (ABV). Typically, the alcohol content of the beer beverage will be less than about 15%, less than about 10%, less than about 8%, less than about 6%, less than about 5%, or less than about 4.5%. For example, the alcohol content of the beer beverage may range from about 2% to about 10%, from about 2% to about 8%, from about 2% to about 6%, from about 2% to about 5%, from about 2% to about 4.5%, or from about 3% to about 5% alcohol by volume.

Other objects and features will be in part apparent and in part pointed out hereinafter.

When introducing elements of the present disclosure or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the above, it will be seen that several objects of the disclosure are achieved and other advantageous results attained.

As various changes could be made in the above products and methods without departing from the scope of the disclosure, it is intended that all matter contained in the above description shall be interpreted as illustrative and not in a limiting sense.

1. A method of producing a beer beverage having a reduced carbohydrate content, the method comprising:
(a) providing a fermented malt beverage; and
(b) subjecting a beverage fraction comprising the fermented malt beverage to a reverse osmosis stage, thereby producing a reverse osmosis permeate; and
(c) combining the reverse osmosis permeate with hops or an extract or essence thereof;
thereby producing a beer beverage having a carbohydrate content of less than about 1 gram per 355 mL serving and an alcohol content of at least about 2% ABV.

2. A method of producing a beer beverage having an increased real degree of fermentation (RDF), the method comprising:
(a) providing a fermented malt beverage;
(b) subjecting a beverage fraction comprising the fermented malt beverage to a reverse osmosis stage, thereby producing a reverse osmosis permeate; and
(c) combining the reverse osmosis permeate with hops or an extract or essence thereof;
thereby producing a beer beverage having an RDF of at least about 94 and an alcohol content of at least about 2% ABV.

3. The method of claim 1 wherein the fermented malt beverage is free of hops.

4. The method of claim 2 wherein the beer beverage has an RDF of at least about 94.5, at least about 95, at least about 95.5, at least about 96, at least about 96.5, at least about 97, at least about 97.5, at least about 98, at least about 98.5, at least about 99, or at least about 99.5.

5. The method of claim 1 wherein the beer beverage has a carbohydrate content of less than about 0.5 grams per 355 mL.

6. The method of claim 1 wherein the fermented malt beverage is prepared via fermentation of an aqueous malt mixture comprising barley malt, yeast, and water.

7. The method of claim 6 wherein the fermented malt beverage is prepared via fermentation of an aqueous malt mixture comprising barley malt, yeast, water, and one or more conventional beer brewing adjuncts,
wherein the one or more conventional beer brewing adjuncts are selected from the group consisting of grains, sugars, rice, corn, wheat, cane sugar, and dextrose.

8-11. (canceled)

12. The method of claim 2 wherein the fermented malt beverage has an RDF of from about 80 to about 92, or from about 84 to about 88.

13-14. (canceled)

15. The method of claim 2 wherein the fermented malt beverage has an alcohol content of from about 2% to about 12% ABV.

16. The method of claim 1 wherein the fermented malt beverage has a carbohydrate content of at least about 1 gram, at least about 1.5 grams, at least about 2 grams, at least about 2.5 grams, at least about 3 grams, at least about 3.5 grams, at least about 4 grams, at least about 4.5 grams, or at least about 5 grams per 355 mL serving.

17. The method of claim 1 wherein the fermented malt beverage is subjected to one or more conventional beer filtration stages prior to the reverse osmosis stage.

18-19. (canceled)

20. The method of claim 1 wherein the beverage fraction entering one or more reverse osmosis units has a temperature of at least about 0° C., at least about 1° C., at least about 2° C., at least about 3° C., at least about 4° C., at least about 5° C., at least about 6° C., at least about 7° C., at least about 8° C., at least about 9° C., or at least about 10° C., and
wherein the beverage fraction entering one or more reverse osmosis units has a temperature of from about 1.5° C. to about 18° C., from about 1.5° C. to about 16° C., from about 4° C. to about 16° C., or from about 7° C. to about 13° C.

21-22. (canceled)

23. The method of claim 1 wherein the beverage fraction entering one or more reverse osmosis units has a pressure of from about 4750 kPa to about 7000 kPa, and
wherein the beverage fraction exiting one or more reverse osmosis units has a pressure of from about 10 kPa to about 350 kPa.

24-25. (canceled)

26. The method of claim 1 wherein the reverse osmosis stage comprises two or more reverse osmosis units.

27. The method of claim 26 wherein the beverage fraction entering each reverse osmosis unit has a temperature of from about 0° C. to about 18° C.,
wherein the beverage fraction entering each reverse osmosis unit has a pressure of at least about 4750 kPa, at least about 5500 kPa, at least about 5750 kPa, or at least about 6000 kPa, and
wherein the beverage fraction exiting each reverse osmosis unit has a pressure of less than about 400 kPa, less than about 350 kPa, less than about 300 kPa, less than about 250 kPa, less than about 200 kPa, less than about 150 kPa, or less than about 100 kPa.

28-32. (canceled)

33. The method of claim 1 wherein the carbohydrate content of the reverse osmosis permeate is reduced by at least about 10%, at least about 20%, at least about 30%, at least about 40%, at least about 50%, at least about 60%, at least about 70%, at least about 80%, or at least about 90% as compared to the carbohydrate content of the fermented malt beverage,
wherein the reverse osmosis permeate retains at least about 50%, at least about 60%, at least about 70%, at least about 80%, at least about 90%, at least about 95%, at least about 98%, or at least about 99% of the alcohol content of the beverage fraction entering the reverse osmosis stage.

34-37. (canceled)

38. The method of claim 1 wherein the reverse osmosis permeate has an alcohol content of from about 2% to about 10%, from about 2% to about 8%, from about 2% to about 6%, from about 2% to about 5%, from about 2% to about 4.5%, or from about 3% to about 5% ABV,
wherein the carbohydrate content of the beer beverage is reduced by at least about 10%, at least about 20%, at least about 30%, at least about 40%, at least about 50%, at least about 60%, at least about 70%, at least about 80%, or at least about 90% as compared to the carbohydrate content of the fermented malt beverage, and
wherein the beer beverage has an alcohol content of at least about 2.5%, at least about 3%, at least about 4%, at least about 5%, at least about 6%, at least about 7%, or at least about 8% ABV.

39-40. (canceled)

41. The method of claim 2 wherein the beer beverage has an alcohol content of less than about 15%, less than about 10%, less than about 8%, less than about 6%, less than about 5%, or less than about 4.5% ABV.

42. The method of claim 2 wherein the beer beverage has an alcohol content of from about 2% to about 10%, from about 2% to about 8%, from about 2% to about 6%, from about 2% to about 5%, from about 2% to about 4.5%, or from about 3% to about 5% ABV.

43. A beer beverage prepared according to the method of claim 1.

44-50. (canceled)
